(19) United States
(12) Patent Application Publication
(10) Pub. No.: US 2016/0172997 A1
(43) Pub. Date: Jun. 16, 2016

(54) MODULAR POWER CONVERSION PLATFORM

(71) Applicant: Caterpillar Inc., Peoria, IL (US)

(72) Inventors: Eric M. Andris, Dunlap, IL (US); Robert W. Lindsey, Washington, IL (US)

(73) Assignee: Caterpillar Inc., Peoria, IL (US)

(21) Appl. No.: 14/567,298

(22) Filed: Dec. 11, 2014

(51) Int. Cl. H02M 7/44

(52) U.S. Cl. CPC H02M 7/44

(57) ABSTRACT

A modular inverter unit for an inverter for generating an alternating current (AC) output based on a direct current (DC) input is disclosed. The modular inverter unit includes an input terminal configured to receive the DC input. The modular inverter unit further includes a power semiconductor device communicably coupled to the input terminal and encapsulated within a potting material. The power semiconductor device is configured to generate the AC output. The modular inverter unit further includes an output terminal communicably coupled to the power semiconductor device and configured to supply the AC output.

### TECHNICAL FIELD

The present disclosure relates to a modular power conversion platform and a method of manufacturing the modular power conversion platform.

### BACKGROUND

Machines driven by an electric system include a generator coupled to an engine to convert mechanical power to electrical power. A rectifier is coupled to the generator to convert an alternating current (AC) output generated by the generator into a direct current (DC) output. Typically, an inverter is used for converting the DC output received from the rectifier into an AC output. The AC output is supplied to one or more motors associated with ground engaging members of the machine. The inverter regulates the magnitude and frequency of the AC output as per power requirements of the motors. The inverter generally includes one or more power semiconductor devices such as IGBTs, power diodes, or MOSFETs for converting the DC input into the AC output. The inverter also includes other electric components such as capacitors, sensors and control circuitry. Failure in one of the power semiconductor devices and/or the electric components may require replacement of the entire inverter as detection and/or replacement of individual components is difficult.

US Patent Publication Number 20120312612 discloses an apparatus for a vehicle. The apparatus includes a structural enclosure to attach both first and second spaced battery module housings while spanning the gap between the spaced battery module housings. The structural enclosure supports power electronics and allows connection of the power electronics to the battery modules through the structural enclosure.

### SUMMARY OF THE DISCLOSURE

In one aspect of the present disclosure, a modular inverter unit for generating an alternating current (AC) output based on a direct current (DC) input is provided. The modular inverter unit includes input terminals configured to receive the DC input. The modular inverter unit further includes a power semiconductor device communicably coupled to the input terminal and encapsulated within a potting material. The power semiconductor device is configured to generate the AC output. The modular inverter unit further includes an output terminal communicably coupled to the power semiconductor device and configured to supply the AC output.

In another aspect of the present disclosure, an inverter is provided. The inverter includes a heat sink member and a plurality of modular inverter units detachably coupled to the common heat sink member. The plurality of modular inverter units is disposed adjacent to each other. One of the modular inverter units includes an input terminal configured to receive the DC input. The modular inverter unit further includes a power semiconductor device communicably coupled to the input terminal and encapsulated within a potting material. The power semiconductor device is configured to generate the AC output. The modular inverter unit further includes an output terminal communicably coupled to the power semiconductor device and configured to supply the AC output.

In yet another aspect of the present disclosure, a method of manufacturing a modular inverter unit for an inverter is provided. The modular inverter unit includes a power semiconductor device connected between an input terminal and an output terminal. The power semiconductor device is configured to receive a direct current (DC) input though the input terminal and supply an alternating current (AC) output based on the DC input. The method includes disposing the power semiconductor device within a mold defining an opening. The method further includes dispensing a potting material through the opening of the mold to fully enclose the power semiconductor device and at least partly enclose the input terminal and the output terminal. The method further includes curing the potting material to encapsulate the power semiconductor device, sensitive control electronics, sensors, the input terminal and the output terminal therein.

Other features and aspects of this disclosure will be apparent from the following description and the accompanying drawings.

### BRIEF DESCRIPTION OF THE DRAWINGS

FIG. 1 is a block diagram illustrating an exemplary electric drive system of a machine having an inverter;

FIG. 2 is a perspective view of a modular inverter unit of the inverter associated with the electric drive system of FIG. 1, according to an embodiment of the present disclosure;

FIG. 3 is a partially exploded perspective view of the inverter showing a plurality of the modular inverter unit disposed adjacent to each other on a heat sink member, according to an embodiment of the present disclosure;

FIG. 4 is a partially exploded perspective view of an inverter, according to another embodiment of the present disclosure; and

FIG. 5 is a flowchart illustrating a method of manufacturing the modular inverter unit, according to an embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

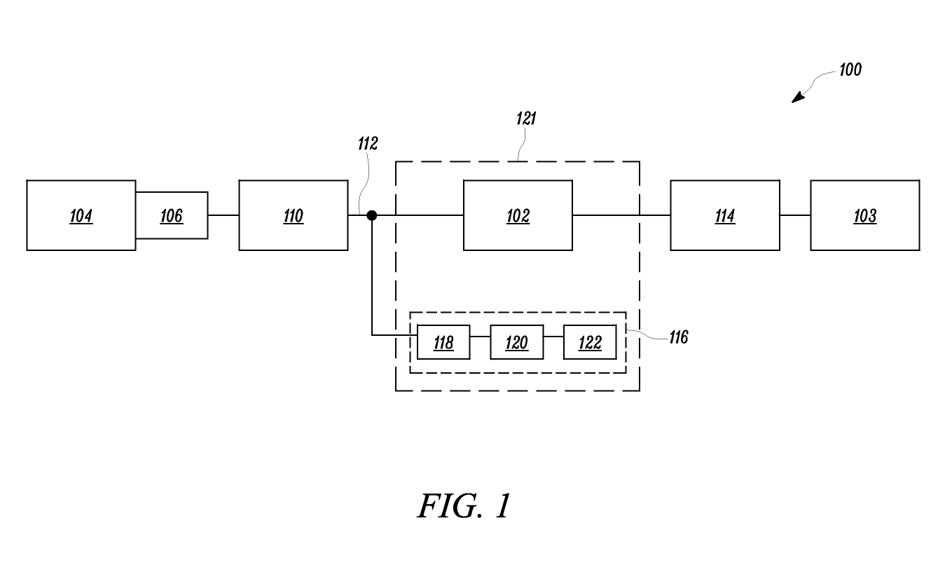

FIG. 1 is a block diagram illustrating an exemplary electric drive system 100 of a machine having an inverter 102. The machine may be an on-highway or an off-highway vehicle used for industrial operations such as mining, construction, farming, transportation, forestry, material handling, or any other industrial operations known in the art. The machine may include a frame for supporting the electric drive system 100. The electric drive system 100 is further configured to drive ground engaging members 103 of the machine. The ground engaging members 103 may include one or more track assemblies or a plurality of wheels. The machine may further include an operator cab that encloses various operator input devices and interfaces for controlling one or more operations of the machine.

The electric drive system 100 includes a power source 104, such as an internal combustion engine. The power source 104 is coupled to a generator 106. The generator 106 may be configured to produce an alternating current (AC) output based on power received from the power source 104. Further, the generator 106 is electrically coupled to a rectifier 110 to convert the AC output into a direct current (DC) output. The rectifier 110 is further coupled to the inverter 102 via a DC link 112 to supply the DC output. The inverter 102 is configured to convert the DC output received from the rectifier 110 into an AC output. The inverter 102 is further electrically coupled to one or more electric motors 114. The inverter 102 may be further configured to supply variable frequency AC output to provide variable power to the electric motors 114 based on operational demands of the machine. The electric motors 114 are coupled to the ground engaging members 103 to operate the ground engaging members 103 based on the AC output from the inverter 102. It may also be contemplated that the electric motors 114 may also supply power through the DC link 112 during a power regeneration event (e.g., when gravity or momentum acting on the ground engaging members 103 drives the electric motors 114). In an embodiment, an energy storing device (not shown), such as a battery, may also be provided to store at least part of the electrical energy generated from the generator 106 or generated during power regeneration.

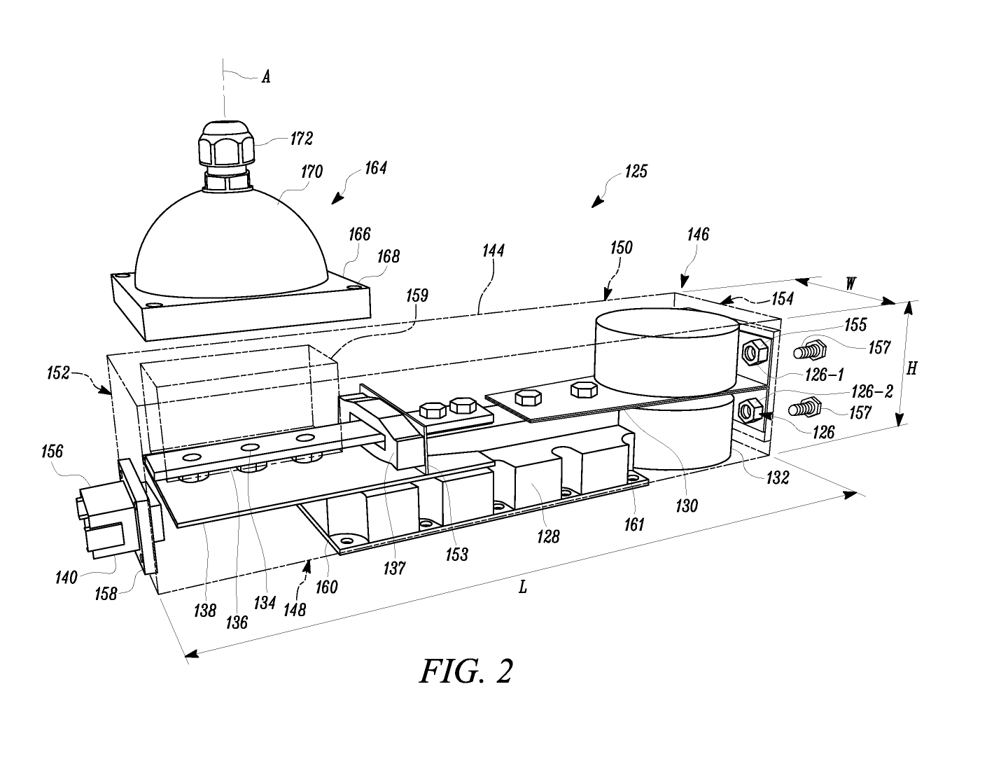

In an embodiment, the machine includes an auxiliary power converter unit 116 configured to supply electric power to one or more external electric devices (not shown). The auxiliary power converter unit 116 is electrically connected to the DC link 112 to receive the DC output from the rectifier 110. The auxiliary power converter unit 116 includes an additional inverter 118 configured to be electrically connected to the DC link 112. The inverter 118 is also configured to convert the DC output received from the rectifier 110 into an AC output. The AC output is further communicated to a harmonic filter unit 120. The harmonic filter unit 120 may be configured to enhance quality of the AC output by reducing undesirable harmonic content in the AC output in order to meet power quality requirements for external electric devices, such as power tools, welding equipment, and the like. The auxiliary power converter unit 116 further includes a power distribution module 122. The power distribution module 122 may include phase converters such as static or rotary phase converters to convert a single phase electric power into a three phase or vice versa. The inverter 102 includes one or more modular inverter units 125 that will be described in detail with reference to FIG. 2.

In an embodiment, the additional inverter 118 may include additional modular inverter units 125 which may be integrated with the inverter 102. Moreover, functionalities of the harmonic filter unit 120 and the power distribution module 122 may also be combined with the inverter 102. In such case, the additional modular inverter units 125 may include electric components required for performing functions of the harmonic filter unit 120 and the power distribution module 122. Thus, the electric drive system 100 of the machine may be provided with an integrated inverter assembly 121 for generating AC output for supply to the electric motors 114 and the external electric devices.

FIG. 2 is a perspective view of the modular inverter unit 125, according to an embodiment of the present disclosure. Reference will also be made to FIG. 1 for describing various components of the modular inverter unit 125. The modular inverter unit 125 is configured to generate the AC output based on the DC input received from the rectifier 110 through the DC link 112. The modular inverter unit 125 includes an input terminal 126 configured to receive the DC input from the rectifier 110. The input terminal 126 is coupled to the DC link 112. The modular inverter unit 125 further includes a power semiconductor device 128 communicably coupled to the input terminal 126. In the illustrated embodiment, the power semiconductor device 128 includes one or more insulated gate bipolar transistors (IGBT). In other embodiments, the power semiconductor device 128 may include at least a thyristor, a power diode, or a metal oxide semiconductor field effect transistor (MOSFET). Further, the power semiconductor device 128 may include input terminals (not shown) and output terminals (not shown). The power semiconductor device 128 is communicably coupled to the input terminal 126 through a direct current (DC) bus bar 130. The DC bus bar 130 is configured to supply the DC input received at the input terminal 126 to the power semiconductor device 128. The modular inverter unit 125 further includes one or more capacitors 132 coupled between the input terminal 126 and the power semiconductor device 128. In the illustrated embodiment, the modular inverter unit 125 includes two capacitors 132. However, in other embodiments, the modular inverter unit 125 may include any number of capacitors 132 as per design requirements. The capacitors 132 may be configured to reduce ripple in the DC input received from the rectifier 110. Further, the capacitors 132 may also isolate the DC link 112 from transients generated in the power semiconductor device 128. In an example, the capacitors 132 may be a polypropylene film capacitor.

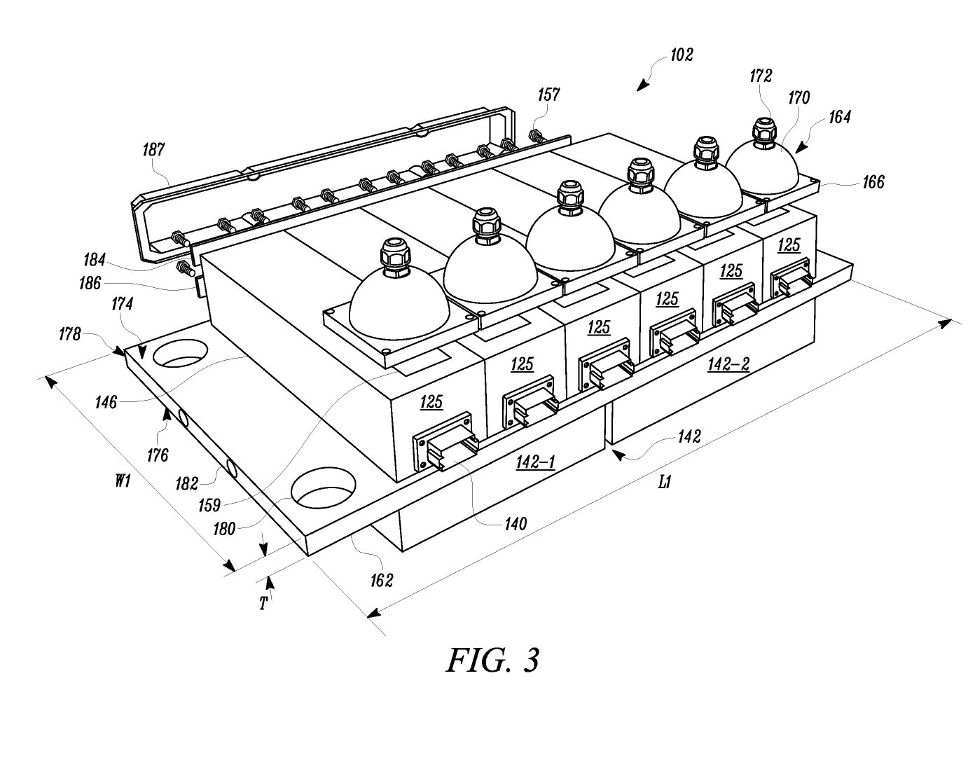

The modular inverter unit 125 further includes an output terminal 134 communicably coupled to the power semiconductor device 128. The output terminal 134 is configured to supply the AC output to the electric motors 114. Specifically, the output terminal 134 is electrically connected with the one or more electric motors 114 of the machine via one or more electric cables (not shown). Further, the power semiconductor device 128 is communicably coupled to the output terminal 134 via an alternating current (AC) bus bar 136. The AC bus bar 136 is configured to communicate the AC output from the power semiconductor device 128 to the output terminal 134. The modular inverter unit 125 further includes a current sensor 137 disposed around the AC bus bar 136. The current sensor 137 may be configured to detect current that passes through the AC bus bar 136 and generate signal based on the detected current. The modular inverter unit 125 further includes a drive circuit member 138 communicably coupled to the power semiconductor device 128. The drive circuit member 138 is communicably coupled to a connector 140. Moreover, the connector 140 is coupled to a controller 142 (shown in FIG. 3). In an example, the drive circuit member 138 may be a printed circuit board including various electronic components, such as microprocessors, resistors, capacitors and diodes. The drive circuit member 138 may also perform all other control, sensing, fault, and feedback functions necessary for the operation of the modular inverter unit 125. The drive circuit member 138 may be configured to control AC output voltage, current, and frequency. Thus, various functions, including, but not limited to, adjusting frequency of the AC output may be controlled by the controller 142 through the drive circuit member 138. The controller 142 may also regulate multiple modular inverter units 125 as will be explained later with reference to FIG. 3.

In an embodiment, the modular inverter unit 125 is encapsulated within a potting material 144 such that the potting material 144 along with various electric components of the modular inverter unit 125 together may define a block 146. In FIG. 2, boundary line of the block 146 is shown in dash-dot lines for illustrative purposes, specifically, to indicate the encapsulation of various electric components within the potting material 144. The power semiconductor device 128, the capacitors 132, the DC bus bar 130, the AC bus bar 136, the drive circuit member 138 and the current sensor 137 may be fully encapsulated within the potting material 144. In the illustrated embodiment, the block 146 may have a cuboidal shape having a length ‘L’, a width ‘W’ and a height ‘H’. However, the block 146 may have any alternative shape, for example, trapezoidal. The length ‘L’, the width ‘W’ and the height ‘H’ of the block 146 may be designed based on dimensions of the various electric components encapsulated therein, for example, the power semiconductor device 128, the capacitors 132, and the drive circuit member 138. In some embodiments, a metallic or non-metallic enclosure may be used to define an outer boundary of the block 146. Further, the metallic or non-metallic enclosure may serve as a mold for disposing the various electric components therein and for containing the potting material 144 to encapsulate the electric components. The potting material 144 may encapsulate the electric components by pouring, injecting or any other method known in the art.

The block 146 includes a bottom surface 148 and a top surface 150 disposed at the height ‘H’ from the bottom surface 148. In the illustrated embodiment, the top surface 150 and the bottom surface 148 are substantially planar. However, it may be contemplated that the top surface 150 may have projections or cutouts based on the electric components of the modular inverter unit 125 encapsulated within the potting material 144. The block 146 further includes a first side surface 152 and a second side surface 154 disposed at the length ‘L’ from the first side surface 152. Further, the block 146 includes a pair of lateral surfaces spaced apart from each other by the width ‘W’.

In the illustrated embodiment, the connector 140 is partly encapsulated within the potting material 144 at the first side surface 152 of the block 146. However, in alternative embodiments, the connector 140 may be partially encapsulated at any other surface of the block 146, such as the top surface 150 or one of the lateral side surfaces. The connector 140 may have an elongated body 156 having one end configured to couple with the drive circuit member 138 and another end with a plurality of pins (not shown) configured to couple with a control cable connected to the controller 142. The connector 140 may also include a flange 158 disposed between the ends of the elongate body 156. A portion of the elongate body 156 between the flange 158 and the end coupled with the drive circuit member 138 is encapsulated within the potting material 144.

Further, as shown in FIG. 2, the input terminal 126 is partly encapsulated within the potting material 144 at the second side surface 154 of the block 146. However, it may be contemplated that the input terminal 126 may be partially encapsulated at the top surface 150 or one of the lateral surfaces. The output terminal 134 is partly encapsulated within the potting material 144 at the top surface 150. Further, the block 146 includes a void 159 extending from the top surface 150 to access the output terminal 134 coupled to the AC bus bar 136. However, it may be contemplated that the void 159 may be defined on one of the lateral surfaces to access the output terminal 134. The AC bus bar 136 may be made from a current conducting material, such as copper in the form an elongated bar. The AC bus bar 136 may be disposed along the length ‘L’ of the block 146, such that one end of the AC bus bar 136 may be coupled to the power semiconductor device 128 and another end may be coupled with the output terminals 134. In an example, the output terminal 134 may include a nut (not shown) and a bolt (not shown) coupled to the AC bus bar 136 for connecting with the electric cables. The electric cables may be used for supplying the AC output received from the AC bus bar 136 to the electric motors 114.

The modular inverter unit 125 further includes a cover member 164 mounted on the top surface 150 of the block 146 above the void 159. In FIG. 2, the cover member 164 is shown in an exploded view. The cover member 164 includes a flange portion 166 adapted to attach with the top surface 150. A plurality of holes 168 may be defined in the flange portion 166 to receive fastening members, such as bolts (not shown). The block 146 may also include a plurality of holes (not shown) corresponding to the plurality of holes 168 to engage with the fastening members. The flange portion 166 may further include a central opening (not shown) configured to receive the electric cables therethrough. The cover member 164 further includes a rotating body 170 disposed on the flange portion 166. Further, the rotating body 170 is rotatable about a central axis ‘A’ relative to the flange portion 166, which allows the electric cables to emerge at various trajectories most suitable for a particular application. The rotating body 170 may include one or more through holes (not shown) configured to receive the electric cables therethrough. The cover member 164 also includes one or more coupling members 172 for holding the electric cables that are received through the through holes of the rotating body 170 so that the electric cable may be manipulated without affecting the connection with the output terminal 134. In an example, the coupling member 172 may be a cable gland.

The power semiconductor device 128 includes a base 160 that may be partly encapsulated within the potting material 144. The power semiconductor device 128 is encapsulated within the potting material 144 such that the base 160 may be positioned adjacent to the bottom surface 148 of the block 146. The base 160 includes a plurality of apertures 161 to receive fastening members (not shown). Further, the base 160 is configured to be mounted on a heat sink member 162 that will be described in detail later with reference to FIG. 3.

The DC bus bar 130 may be made from a current conducting material, such as copper in the form of an elongated bar. The DC bus bar 130 is disposed along the length ‘L’ of the block 146, such that one end of the DC bus bar 130 is coupled to the power semiconductor device 128 and another end is coupled to the input terminal 126. The input terminal 126 includes a positive input terminal 126-1 and a negative input terminal 126-2. The positive input terminal 126-1 may receive a positive DC input and the negative input terminal 126-2 may receive a negative DC input. Further, the positive input terminal 126-1 and the negative input terminal 126-2 may be defined in a flange associated with the DC bus bar 130. The flange may include a pair of holes spaced apart each other. Each of the holes in the flanges may be associated with a nut 155 and a bolt 157 for connection with one or more electric cables.

In an embodiment, the capacitors 132 are coupled to the DC bus bar 130 and positioned between the power semiconductor device 128 and the second side surface 154. Further, the capacitors 132 may have a thickness substantially similar to a thickness of the power semiconductor device 128. In the illustrated embodiment, one capacitor 132 is disposed below the DC bus bar 130 and another capacitor 132 is disposed above the DC bus bar 130.

The drive circuit member 138 may be a circuit board disposed on top of the power semiconductor device 128. Various electronic components of the drive circuit member 138 may be located between the power semiconductor device 128 and the first side surface 152. Further, the connector 140 disposed adjacent to the first side surface 152 is communicably coupled with the electronic components of the drive circuit member 138. The current sensor 137 may be disposed around the AC bus bar 136 between the output terminal 134 and the power semiconductor device 128. The current sensor 137 is supported on a wall 153 projecting vertically from the drive circuit member 138.

FIG. 3 illustrates a perspective view of the inverter 102 having a plurality of the modular inverter units 125 disposed adjacent to each other, according to an embodiment of the present disclosure. In the illustrated embodiment, the inverter 102 may include six modular inverter units 125 which are disposed on the heat sink member 162. The heat sink member 162 may be a metallic plate having an upper surface 174 and a lower surface 176 distal from the upper surface 174. The upper surface 174 of the heat sink member 162 may be substantially planar and abuts a bottom surface (not shown) of the base 160 of the power semiconductor device 128.

The heat sink member 162 has a length ‘L1’ and a width ‘W1’ to mount the modular inverter units 125 on the upper surface 174 thereof. The width ‘W1’ of the heat sink member 162 may be substantially equal to or greater than the length ‘L’ of the modular inverter unit 125. The heat sink member 162 further has a thickness ‘T’ defining between the upper surface 174 and the lower surface 176. A side surface 178 extends between the upper surface 174 and the lower surface 176. A plurality of mounting holes 180 is defined proximate to the side surfaces 178 of the heat sink member 162. Each of the plurality of mounting holes 180 may be configured to receive a fastening member (not shown) therethrough to mount the heat sink member 162 on the frame of the machine.

The heat sink member 162 further includes a plurality of holes (not shown) for mounting the modular inverter unit 125 on the upper surface 174 thereof. Further, each of the plurality of holes may be configured to receive a fastening member. In an embodiment, the number of holes may be corresponding to the plurality of apertures 161 defined in the base 160 of the power semiconductor device 128. Thus, the modular inverter units 125 may be mounted on the heat sink member 162 with the fastening members. In other embodiments, a plurality of holes may be defined in the block 146 adjacent to the bottom surface 148 thereof to mount the modular inverter unit 125 on the heat sink member 162.

Each of the modular inverter units 125 may be disposed adjacent to each other in the heat sink member 162 along the length ‘L1’. The first side surface 152 along with the connector 140 of each of the modular inverter units 125 may be aligned each other. Similarly, the second side surface 154 along with the input terminal 126 of each of the modular inverter units 125 may be aligned each other. The inverter 102 further includes a positive terminal bar 184 connected with the positive input terminals 126-1 of two or more adjacent modular inverter units 125. In the illustrated embodiment, the positive terminal bar 184 may be a single integral component. In another embodiment, the positive terminal bar 184 may include multiple components for connection with positive input terminals 126-1 of the modular inverter units 125. The inverter 102 further includes a negative terminal bar 186 connected with the negative input terminals 126-2 of two or more adjacent modular inverter units 125. In the illustrated embodiment, the negative terminal bar 186 may be a single integral component. In another embodiment, the negative terminal bar 186 may include multiple components for connection with negative input terminals 126-2 of the modular inverter units 125. The inverter 102 further includes a housing member 187 configured to enclose the input terminals 126 of each of the modular inverter units 125. The housing member 187 may be attached with the second side surface 154 of the modular inverter units 125 via fastening members (not shown).

The connector 140 of each of the modular inverter units 125 may be coupled to the controller 142. The controller 142 includes a first control module 142-1 and a second control module 142-2. The first control module 142-1 and the second control module 142-2 are disposed on the lower surface 176 of the heat sink member 162. The first control module 142-1 may be configured to be in electric communication with the generator 106 and each of the modular inverter units 125. Similarly, the second control module 142-2 may be configured to be in electric communication with the electric motors 114 and each of the modular inverter units 125. Further, the first control module 142-1 and the second control module 142-2 may communicate to each other based on the AC output generated by the generator 106 and the AC input required for the electric motors 114. The first control module 142-1 and the second control module 142-2 may also be configured to control the power semiconductor device 128 through the drive circuit member 138 to supply the AC output to the electric motors 114 at various frequencies.

The heat sink member 162 may further include a plurality of channels 182 configured to facilitate cooling of the heat sink member 162. Various electric components of the modular inverter unit 125, including the power semiconductor device 128, may generate heat during operation. The generated heat may have to be dissipated to prevent premature failure of the power semiconductor device 128 and other related electric components. The channels 182 may be defined longitudinally within a body of the heat sink member 162. A cooling fluid, such as air or a liquid coolant may flow through the channels 182 to absorb heat from the heat sink member 162. In other embodiments, the heat sink member 162 may be configured to provide direct coolant flow to the base 160 of the power semiconductor device 128. Further, fins may also be provided on the lower surface 176 and the side surfaces 178 of the heat sink member 162 to enhance heat dissipation.

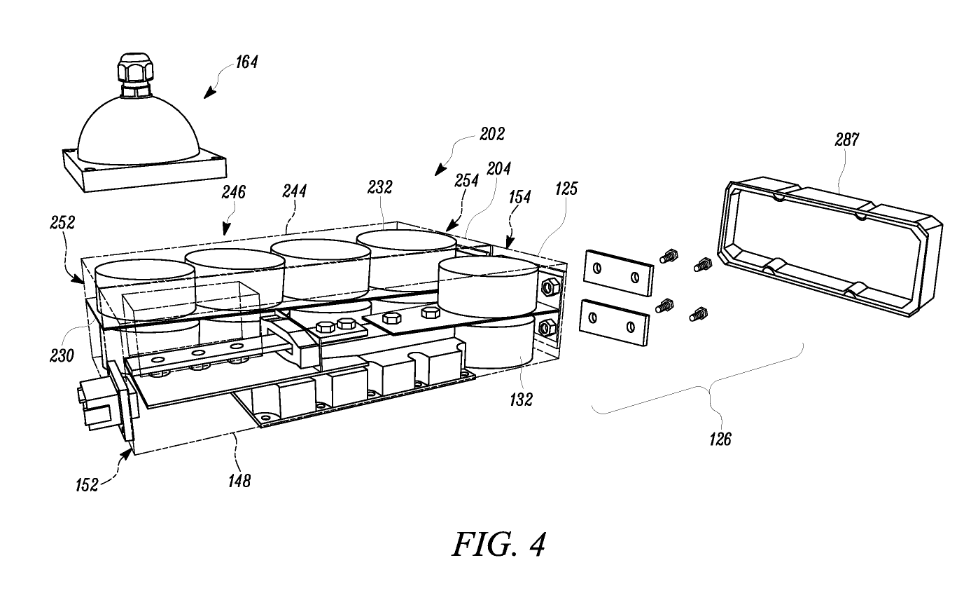

FIG. 4 illustrates a partially exploded perspective view of an inverter 202, according to another embodiment of the present disclosure. The inverter 202 includes the modular inverter unit 125 and an additional modular unit 204 disposed adjacent to one of the lateral surfaces of the modular inverter unit 125. The additional modular unit 204 includes a plurality of capacitors 232 encapsulated within a potting material 244 to define a block 246 having a shape substantially similar to the shape of the block 146. The plurality of capacitors 232 may provide a more stable DC output to one or more power semiconductor devices 128 of the modular inverter unit 125. A separate bank of such capacitors 232 may be used when a magnitude of the DC input to the inverter 202 may require a higher number of capacitors 232, which may be accommodated in a single modular inverter unit with a power semiconductor device.

In the illustrated embodiment, the additional modular unit 204 includes a DC bus bar 230 having an input terminal (not shown). The input terminal may be partly encapsulated within the potting material 244 adjacent to a second side surface 254. Further, the DC bus bar 230 may extend from the second side surface 254 towards a first side surface 252 of the block 246. The input terminal may include a positive input terminal (not shown) and a negative input terminal (not shown). The positive input terminal and the negative input terminal may be defined in a flange (not shown) associated with the DC bus bar 230. The flange having at least a pair of holes (not shown). Each of the holes in the flanges may correspond to the positive input terminal and the negative input terminal. A first set of the capacitors 232 may be disposed above the DC bus bar 230 and a second set of the capacitors 232 may be disposed below the DC bus bar 230. The input terminals of the modular inverter unit 125 and the additional modular unit 204 may be configured to be in communication with each other. Further, a housing member 287 may be disposed on the second side surfaces 154 and 254 of the modular inverter unit 125 and the additional modular unit 204 for enclosing the input terminals 126.

In various embodiments, multiple modular units, such as the additional modular unit 204 having various functions may be connected each other depend on power requirement for a specific application. Further, type of various electric components and quantity of similar electronic components may vary depends on function of each of the multiple modular units. Moreover, each of the multiple modular units may have a compatible form factor and universal electrical interfaces for defining a compact power conversion unit. The compatible form factor may be defined as a size of the modular unit and arrangement of various electric components within the modular unit. The compact power conversion unit may be further made to be easily adaptable for similar power conversion applications. Also, each of the multiple modular units may be mounted on a single heat sink member and supplied with a common cooling medium through plurality of channels provided in the heat sink member. Further, a common controller may be used to couple with each of the multiple modular units to regulate the power output.

The modular inverter units 125, as described above, are exemplary in nature and various other electric components may be additionally encapsulated within the potting material 144. For example, inductors and contactors may be encapsulated within the potting material 144. Further, voltage warning lamps and diagnostic lamps may be encapsulated within the potting material 144 of the modular inverter unit 125. Moreover, protection and distribution elements such as circuit breakers, junction blocks and fuses may be encapsulated within the potting material 144. Energy storage elements such as batteries and ultra-capacitors, and accessory converters such as intermediate bus converters and battery chargers may be encapsulated within the potting material 144. Additionally, a ground fault detection module, a control/user interface module, a display module and resistor module may also be encapsulated within the potting material 144. It may be contemplated that the aforesaid electric components may be partly or fully encapsulated within the potting material 144 depending on space availability within the modular inverter unit 125. Further, the aforesaid electric components may be disposed in various modular inverter units as per requirements. Such modular inverter units may also be electrically coupled to each other to supply a required power output.

### INDUSTRIAL APPLICABILITY

The present disclosure relates to the modular inverter unit 125 and a method 500 of encapsulating the power semiconductor device 128, the input terminal 126 and the output terminal 134, and various electric components, such as the capacitors 132, the drive circuit member 138 and the current sensor 137 of the modular inverter unit 125 within the potting material 144. One or more such modular inverter units 125 may be stacked together on the heat sink member 162 to form the inverter 102 of the machine.

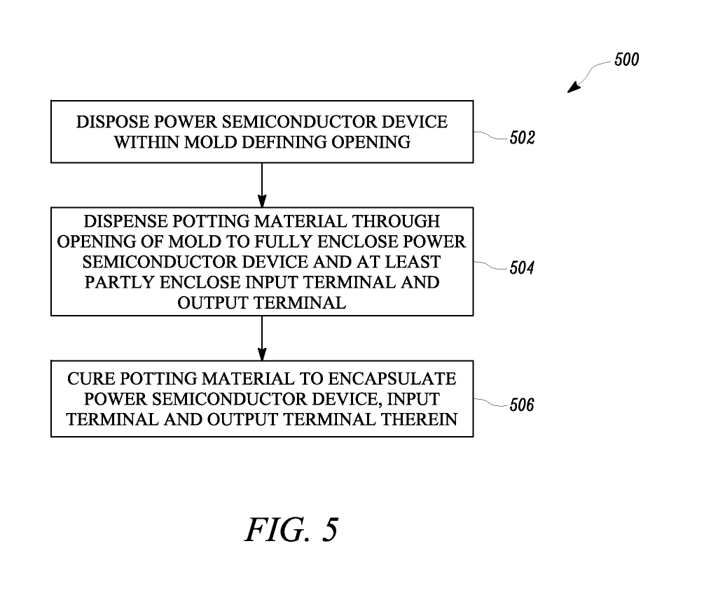

FIG. 5 shows a flow chart for illustrating the method 500 of manufacturing the modular inverter unit 125, according to an embodiment of the present disclosure. At step 502, the method includes disposing the power semiconductor device 128 within a mold (not shown) defining an opening. The mold may include a bottom plate and a plurality of side plates extending vertically from peripheral edges of the bottom plate. The bottom plate and the side plates may be integrally formed or attached with each other via various methods, such as welding. A height of the plurality of side plates may be substantially equal or greater than the height ‘H’ of the block 146. The bottom and the side plates of the mold may define the opening to receive the potting material 144 therethrough. The bottom plate and the side plates may together define a hollow space that receives the power semiconductor device 128 therein. A length and a width of the hollow space may be equal to the length ‘L’ and the width ‘W’ of the block 146 shown in FIG. 2. The plurality of side plates may include a first side plate and a second side plate configured to define the first side surface 152 and the second side surface 154 of the block 146, respectively.

In an embodiment, the base 160 of the power semiconductor device 128 may be mounted on an inner surface of the bottom plate via fastening members. The bottom plate may include a plurality of holes corresponding to the plurality of apertures 161 defined in the base 160. In an alternative embodiment, the bottom plate may include a slot to receive the base 160 of the power semiconductor device 128 such that, in a mounted position of the power semiconductor device 128, the base 160 may project outside the bottom plate. The DC bus bar 130, the AC bus bar 136 and the drive circuit member 138 may be further coupled to the power semiconductor device 128 as described above with reference to FIG. 2. Further, the capacitors 132 and the current sensor 137 may be disposed on the DC bus bar 130 and the AC bus bar 136, respectively. It may also be contemplated that the aforesaid components may be preassembled with the power semiconductor device 128 and the whole assembly may be disposed within the mold.

The first side plate may include an aperture configured to receive the elongated body 156 of the connector 140. The end of the elongated body 156 coupled with the drive circuit member 138 may be inserted through the aperture. The second side plate of the mold may include a plurality of holes corresponding to the positive terminal input 126-1 and the negative terminal input 126-2 associated with the DC bus bar 130 to receive the bolts 157.

An insert member may be disposed within the mold. The insert member may be adapted to form the void 159 in the block 146 during potting process for access to the output terminal 134 from outside the block 146. In an embodiment, the insert member may be supported with the mold. In an alternative embodiment, the insert member may be supported by a retaining device from outside the mold.

At step 504, the method 500 includes dispensing the potting material 144 through the opening of the mold to fully enclose the power semiconductor device 128 and at least partly enclose the input terminal 126 and the output terminal 134. The potting material 144 may be selected from at least one of an epoxy resin, a polyester, a polyurethane, a silicone elastomer and a combination thereof. In the illustrated embodiment, the potting material 144 is electrically insulating, thermally conductive, shock absorbent, moisture resistant, fatigue resistant and chemically resistant. The potting material 144 may be poured in the mold till a level of the potting material 144 within the mold may reach to a level corresponding to the top surface 150 of the block 146. Pouring of the potting material 144 may be performed by a potting machine. The potting machine may include one or more chambers to store the potting material 144 and an injector for injecting the potting material 144 within the mold at a desired rate and quantity.

At step 506, the method 500 includes curing the potting material 144 to encapsulate the power semiconductor device 128, the input terminal 126 and the output terminal 134 therein. The time required for curing the potting material 144 may vary depending on the type of potting material.

In an embodiment, after the potting material 144 is cured and becomes the block 146 as shown in FIG. 2, the block 146 may be removed from the mold. In another embodiment, the mold may be retained along with the block 146. Thus, the mold may also become an integral part of the modular inverter unit 125.

The modular inverter unit 125 of the present disclosure has optimized dimensions with the height ‘H’, the width ‘W’ and the length ‘L’. Further, a weight of the modular inverter unit 125 may fall within a predetermined range. This may facilitate easy handling of the modular inverter unit 125. The modular inverter unit 125 may also be reused for various other power conversion applications. Further, universal interfaces such as the connector 140, the input terminal 126 and the output terminal 134 may facilitate usage of the modular inverter unit 125 for multiple applications, such as telecommunication, commercial outlets and domestic utilities in addition to machines. Thus, development cost of electric apparatus required for aforesaid applications may be reduced. The modular inverter unit 125 may further facilitate adaptation with various cooling technologies such as air cooling, water cooling, and the like known in the art. As the modular inverter unit 125 is designed as a fully independent functional block, any of the modular inverter units 125 may be quickly replaced with a spare modular inverter unit 125 in case of failure. Hence, the entire inverter 102 may not require replacement. Further, detection of faults may also be more convenient. Hence, replacement and maintenance costs may also be minimized.

Potting the various components of the modular inverter unit 125 may increase durability of the modular inverter unit 125. Further, the modular inverter unit 125 may have improved structural rigidity. The electric components may be protected from external loads and high temperatures developed during operation of the modular inverter units 125. Further, the components may be protected from moisture and chemicals.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A modular inverter unit for an inverter configured to generate an alternating current (AC) output based on a direct current (DC) input, the modular inverter unit comprising:
an input terminal configured to receive the DC input;
a power semiconductor device communicably coupled to the input terminal and encapsulated within a potting material, the power semiconductor device configured to generate the AC output; and
an output terminal communicably coupled to the power semiconductor device and configured to supply the AC output.

2. The modular inverter unit of claim 1, wherein the power semiconductor device comprises at least one of an insulated gate bipolar transistor (IGBT), a thyristor, a power diode, or a metal oxide semiconductor field effect transistor (MOSFET).

3. The modular inverter unit of claim 1 further comprising a capacitor connected between the input terminal and the power semiconductor device, and encapsulated within the potting material.

4. The modular inverter unit of claim 1 further comprising at least one of a DC bus bar configured to communicably couple the input terminal with the power semiconductor device and an AC bus bar configured to communicably couple the power semiconductor device with the output terminal.

5. The modular inverter unit of claim 1 further comprising a drive circuit member communicably coupled to the power semiconductor device and encapsulated within the potting material.

6. The modular inverter unit of claim 5 further comprising a connector configured to communicably couple the drive circuit member to a controller and at least partly encapsulated within the potting material.

7. The modular inverter unit of claim 1, wherein the power semiconductor device comprises a base having a plurality of apertures configured to receive fastening members therein to detachably couple the power semiconductor device to a heat sink member, the base being partly encapsulated within the potting material.

8. The modular inverter unit of claim 1, wherein the potting material is electrically insulating, thermally conductive, shock absorbent, moisture resistant, fatigue resistant and chemically resistant.

9. The modular inverter unit of claim 1, wherein the potting material is selected from at least one of an epoxy resin, a polyester, a polyurethane, a silicone elastomer and a combination thereof.

10. An inverter comprising:
a heat sink member; and
a plurality of modular inverter units detachably coupled to the heat sink member and disposed adjacent to each other, at least one of the plurality of modular inverter units comprising:
an input terminal configured to receive a direct current (DC) input;
a power semiconductor device communicably coupled to the input terminal and encapsulated within a potting material, the power semiconductor device configured to generate the alternating current (AC) output; and
an output terminal communicably coupled to the power semiconductor device and configured to supply the AC output.

11. The inverter of claim 10, wherein the power semiconductor device comprises at least one of an insulated gate bipolar transistor (IGBT), a thyristor, a power diode and a metal oxide semiconductor field effect transistor (MOSFET).

12. The inverter of claim 10 further comprising a capacitor connected between the input terminal and the power semiconductor device, and encapsulated within the potting material.

13. The inverter of claim 10 further comprising at least one of a DC bus bar configured to communicably couple the input terminal with the power semiconductor device and an AC bus bar configured to communicably couple the power semiconductor device with the output terminal.

14. The inverter of claim 10 further comprising a drive circuit member communicably coupled to the power semiconductor device and encapsulated within the potting material.

15. The inverter of claim 14 further comprising a connector configured to communicably couple the drive circuit member to a controller and at least partly encapsulated within the potting material.

16. The inverter of claim 10, wherein the power semiconductor device comprises a base having a plurality of apertures configured to receive fastening members therein to detachably couple the power semiconductor device to a heat sink member, the base being partly encapsulated within the potting material.

17. The inverter of claim 10, wherein the potting material is electrically insulating, thermally conductive, shock absorbent, moisture resistant, fatigue resistant and chemically resistant.

18. The inverter of claim 10, wherein the potting material is selected from at least one of an epoxy resin, a polyester, a polyurethane, a silicone elastomer and a combination thereof.

19. A method of manufacturing a modular inverter unit for an inverter having a power semiconductor device connected between an input terminal and an output terminal, the power semiconductor device configured to receive a direct current (DC) input though the input terminal and supply an alternating current (AC) output based on the DC input, the method comprising:
disposing the power semiconductor device within a mold defining an opening;
dispensing a potting material through the opening of the mold to fully enclose the power semiconductor device and at least partly enclose the input terminal and the output terminal; and
curing the potting material to encapsulate the power semiconductor device, the input terminal and the output terminal therein.

20. The method of claim 19 further comprising removing the cured potting material from the mold.
